(19) United States
(12) Patent Application Publication
(10) Pub. No.: US 2007/0153074 A1
(43) Pub. Date: Jul. 5, 2007

(54) Systems and methods for synchronized on-carrier printing and drying

(75) Inventors: Frank Edward Anderson, Sadieville, KY (US); Richard Earl Corley JR., Richmond, KY (US); Kin Ming Kwan, Lexington, KY (US); Paul J. Sacoto, Lexington, KY (US); Jeanne Marie Saldanha Singh, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc

(21) Appl. No.: 11/323,879

(22) Filed: Dec. 30, 2005

(51) Int. Cl. B41J 2/01

(52) U.S. Cl. 347/102

(57) ABSTRACT

Printing systems such as those comprising a printing device operable for depositing one or more inks upon a substrate and a drying device, such as one operable for emitting radiation having a pre-selected electromagnetic wavelength, for the purpose of drying the one or more inks in a predetermined time period subsequent to the deposition of the one or more inks upon the substrate, wherein the printing device and the drying device are operated at about the same moving speed. Methods of printing, such as those comprising depositing one or more inks onto a substrate using a printing device and drying the one or more deposited inks using a drying device, such as one operable for emitting pre-selected wavelengths of energy that are focused onto the one or more deposited inks in a predetermined time period subsequent to ink deposition, wherein the depositing and the drying are synchronized.

### BACKGROUND OF THE INVENTION

1. Field of the Invention

The present invention relates generally to systems and methods for printing and drying one or more inks applied to a substrate, and specifically, in one embodiment, to systems and methods for applying one or more inks to a substrate using a printing device and drying the deposited inks within a predetermined time period after deposition using a drying device positioned about the printing device on a common carrier, and wherein the operation of the printing device and the drying device are synchronized.

2. Technical Background

There are two types of commonly known inkjet printing systems: continuous stream printing systems and drop-on-demand printing systems. In continuous stream inkjet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field which adjusts the trajectory of each droplet in order to direct it to a gutter for recirculation or a specific location on a recording medium or substrate. In drop-on-demand systems, a droplet of ink is expelled from a discharge nozzle in a print head directly to a position on a substrate in accordance with digital data signals. An ink droplet is not formed or expelled unless it is to be placed on the substrate. Since drop-on-demand systems require no ink recovery, charging, or deflection, they are typically more simple systems than continuous stream systems.

There are currently two general types of conventional drop-on-demand inkjet systems. A first system includes an ink filled channel or passageway having a nozzle on one end and a piezoelectric transducer about the other end that produces pressure pulses. The relatively large size of the transducer prevents close spacing of the nozzles, and physical limitations of the transducer result in low ink drop velocity. Low ink drop velocity seriously diminishes tolerances for drop velocity variation and directionality, thus impacting the system's ability to produce high quality prints. Another shortcoming of drop-on-demand systems that employ piezoelectric devices to expel droplets is their slow printing speed.

A second type of drop-on-demand system is known as a thermal inkjet, and produces high velocity droplets that allow for very close spacing of the nozzles. The major components of this system include a print head having a nozzle on one end and a heater (e.g., a resistive element comprising a resistive layer) about the nozzle. Print signals in the form of an electric current pulse are received in a resistive layer within an ink passageway about the nozzle, causing the ink in the immediate vicinity to evaporate almost instantaneously and create a bubble. Ink at the nozzle is forced out as a propelled droplet as the bubble expands. Once the hydrodynamic motion of the ink stops, the process is repeated. The introduction of droplet ejection systems based upon thermally generated bubbles has led to the development of more simple, lower cost devices as compared to their continuous stream counterparts, and yet have substantially the same high-speed printing capabilities.

Notwithstanding the advantages of the inkjet printing, several disadvantages still exist. First, ink-drying time is often excessive on certain media or substrate types. Second, the optical density of printed images may vary greatly depending on the type of print media or substrate being used.

Known methods and apparatus have been developed to attempt to overcome the disadvantages of excessive drying time, one of which includes post-processing techniques that transform the expelled ink into a thin, coherent solid coating having desired properties. The post processing techniques known in the art utilize a microwave drying device to heat the ink after the substrate has been printed upon by the print head. The microwave drying device is typically located downstream from the print head on a substrate feed path. Thus, a newly printed substrate exits a print zone and enters a drying zone for drying and then exits the printer. By employing this post-processing technique, water and solvents are removed from the ink after printing through physical processes such as absorption and/or evaporation. Systems in which the chemistry of the ink formulation is specifically tailored to a chemical process often include fluid binders or carriers that are solidified by a chemical reaction or through cross-linking using radiation. In solvent based systems, the removal of the solvent is typically carried out through evaporation, or a combination of absorption and evaporation in order to coalesce the polymeric and particle constituents. In water-borne systems, the film formation is more complicated. The ink droplet is applied, and then the water is evaporated in order to coalesce the polymeric/particle constituents. The solvents are then evaporated. With either removal method or process used, fast and efficient drying is desired. Conditions such as the rate of drying, temperature, humidity, airflow rate and solvent type and amounts present in the formulation all affect the film formed.

When employing a thermal inkjet coating method and aqueous-based inks, apart from the drying challenges, jetting characteristics must also be addressed. Thus, most aqueous inkjet inks are comprised mainly of water, glycols and co-solvents. Hence, the paper and polyester substrates used for inkjet printing, which are readily available as supply items, generally have ink receptor coatings made from various formulations and are described in existing literature. However, when creating an ink receptor layer by inkjet printing, the base substrate may not be absorbent and the liquids may need to be removed as multiple layers are printed. Too great an amount of ink on a non-absorbent or semi-absorbent substrate may cause puddling and spreading. Ink absorption may also be dependent on the surface chemistry and characteristics of the substrates, contact angle, surface energy of the substrate, surface tension of the inks, rheology, environmental conditions, etc. Handling a substrate with a low viscosity is difficult due to the ease in flowability of the fluid. Therefore, it becomes crucial to be able to lock-in the coating as quickly as possible by drying or solidifying the fluid instantaneously after printing. Unfortunately, most all-thermal and UV processes are off-line and cumbersome, and drying is not as effective and instantaneous as desired.

In order to achieve rapid heating, some industries have employed infrared heating. The basic principle of infrared heating relies on radiation. Radiation is distinct from conduction and convection in that it transfers energy via electromagnetic (e.g., infrared) waves. Conduction and convection occur when the material being heated is in direct contact with the heat source. In infrared heating, no direct contact with the heat source occurs. Infrared energy travels in straight lines through a space or vacuum (similar to light) and does not produce heat energy until absorbed. The converted heat energy is then transferred in the material by conduction or convection.

All objects above “absolute zero” temperature radiate infrared energy, with warmer objects radiating more energy than cooler objects. Infrared energy radiating from hot objects (heating elements such as Tungsten alloys, Nickel alloys, etc.) strikes the surface of a cooler object (work piece) and is absorbed and converted to heat energy. The classification of infrared waves in the electromagnetic spectrum (in microns) and the associated temperatures (in ° F.) of the heating element to emit different wavelengths of infrared is shown in Table 1.

TABLE 1
The Infrared Spectrum

| | | | 2175° F. | |
|---|---|---|---|---|
| 67° F. | 17,000° F. | 6473° F. | Medium- | 857° F. |
| Ultra-violet | Visible Light | Short-wave IR | wave IR | Long-wave IR |
| 10.0 | 0.3 | 0.76 | 2 | 4 |

In general, infrared waves can be divided into three types: short-wave infrared, from 0.76 to 2 μm; medium-wave infrared, from 2 to 4 μm; and long-wave infrared, from 4 to 10 μm. Each type of infrared wavelength exhibits its own characteristics and behavior. Thus, the selection of an infrared heating device for heating depends mostly on the absorption rate and absorption coefficient of the substrate to be heated and the ink composition. Since most ink compositions used in inkjet printing processes are water-based solutions, water molecule absorption is also of great interest in ink drying. FIG. 1 illustrates the absorption spectrum of water molecules. As can be seen in FIG. 1, water absorbs infrared radiation at about 1.45 μm (the first peak), about 2 μm (the second peak), and about 3 μm (the third peak), with the highest peak relating to maximum infrared absorption. Good absorption is maintained between about 3 and about 10 μm. Therefore, medium- and long-infrared waves are more energy effective and are usually exemplary for heating and drying the water molecules in the ink.

### SUMMARY OF THE INVENTION

In view of the shortcomings of the current systems and methods for printing and drying ink compositions on a substrate, a need exists for new systems and methods for printing and rapidly drying ink deposited upon a substrate. It would be desirable for such systems and methods to include a printing device and a drying device that operate in a controlled and synchronized manner in order to provide improved print quality. It would also be desirable to provide printing systems that utilize a common carrier in order to properly dry deposited ink substantially immediately upon deposition onto a substrate. Desirable systems would include control modules for component operation, temperature control and real-time control, sensors for monitoring the printing system, and components able to deliver ink in a controlled manner and dry the deposited ink in a predetermined time period after deposition and before the substrate exits the printer. Such systems and methods may also include a constant time period between printing and drying.

In one embodiment, the present invention provides an inkjet printing process that includes depositing one or more inks onto a substrate, and subsequently exposing the deposited inks to predetermined wavelengths of energy in order to dry the deposited one or more inks substantially immediately upon deposition. While the present invention is described with respect to inkjet printing processes, the systems and methods of the present invention may be applied to any printing processes that employ aqueous and non-aqueous based inks. An exemplary embodiment of the present invention is directed to inkjet printing processes using ink that is deposited and exposed to infrared energy emitted from a drying device. An exemplary embodiment of the present invention is also directed to an inkjet printing process which comprises synchronously exposing ink droplets ejected on a substrate to infrared radiation from an on-carrier drying device, thereby rapidly drying the images on the substrate in a sub-second time.

In another embodiment, a printing system is provided that includes an on-carrier drying device (e.g., a drying head) capable of emitting radiation having a predetermined electromagnetic wavelength, such as but not limited to, a wavelength in the infrared, ultra-violet, radio frequency, microwave spectrums, that is operated at the same moving speed as a printing device (e.g., a print head). In certain embodiments, the on-carrier drying device includes a radiant infrared emitter, a reflector operable for reflecting, collimating and/or focusing the infrared radiation to the front side of the emitter, an optical system that focuses the infrared energy in a line source, an enclosure that can be latched and loaded in the form factor of a print head and installed on a carrier; an exhaust to remove water vapors from the enclosure, an electrical circuit that controls the infrared emitter, a pyrometer operable for monitoring the temperature on the printed substrate, a sensor at the maintenance station operable for monitoring the infrared power, and/or a medium-wave infrared heater installed at a feeder front or exit operable for preheating the substrate (in the entrance) or ensuring complete drying (at the exit).

In yet another embodiment, the drying device is positioned alongside and about the printing device within a common carrier that moves along a guide rail (such as what might be found in a conventional printer). The drying device is operable for emitting predetermined wavelengths of energy in a manner that is synchronized with the expulsion of ink droplets from the printing device, thereby substantially instantaneously drying the ink on the substrate in a sub-second time.

Additional features and advantages of the invention are set forth in the detailed description which follows and will be readily apparent to those skilled in the art from that description, or will be readily recognized by practicing the invention as described in the detailed description, including the claims, and the appended drawings. It is also to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be merely illustrative and not limiting the intended scope of the claims in any manner.

### BRIEF DESCRIPTION OF THE DRAWINGS

FIG. 1 is a graph of the water molecule absorption coefficient at electromagnetic wave spectrum;

FIG. 2 is a schematic diagram illustrating an exemplary inkjet printer for use in synchronously printing and drying ink ejected onto the surface of a substrate;

FIG. 3 is a schematic diagram of an exemplary drying device including an infrared heat emitter;

FIG. 4 is a schematic diagram of a double end infrared tube for use with an exemplary embodiment of the present invention;

FIG. 5 is a schematic diagram of a single end infrared tube for use with another exemplary embodiment of the present invention;

FIG. 6 is a schematic diagram of an exemplary configuration of an on-carrier ink drying system; and

FIG. 7 is a graph illustrating one example of controlling the print head and drying head in order to print and dry three individual ink segments.

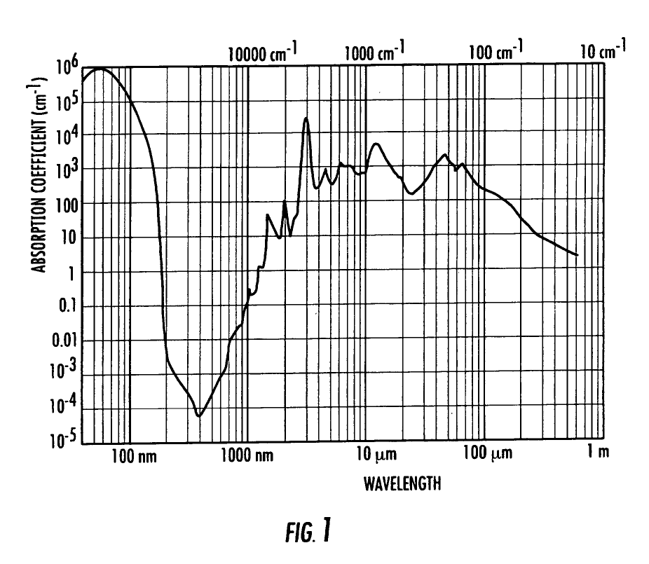

### DETAILED DESCRIPTION OF EXEMPLARY EMBODIMENTS

Reference will now be made in detail to exemplary embodiments of the invention, which are illustrated in the accompanying drawings. Whenever possible, the same reference numerals will be used throughout the drawings to refer to the same or like parts. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The present invention, in one embodiment, provides a thermal inkjet printing system having an inkjet printing apparatus, such as an inkjet printer or a functionally similar component of a multi-function apparatus, including an on-carrier drying device capable of emitting radiation at predetermined wavelengths, such as those in the infrared, ultra-violet, radio frequency, or microwave spectrum. The drying device (also referred to herein as a “dryer”) can be employed to synchronously dry ink droplets on a recording medium or substrate (referred to generically hereinafter as a “substrate”) as the ink droplets are applied to the substrate. However, it should be understood by those skilled in the art that the methods and apparatus of the present invention can be applied with respect to any printing system wherein ink is deposited or printed upon a substrate and thereafter rapidly dried in a synchronized manner to the printing. As used throughout this description, the term “substrate” is intended to mean any media having a surface operable for receiving ink from a printing device. Further, it will be understood by those skilled in the art that the substrate may be any now known or hereafter devised recording media used in printing systems, including, but not limited to, commercially available paper, specialty papers, envelopes, transparencies, labels, card stock and the like.

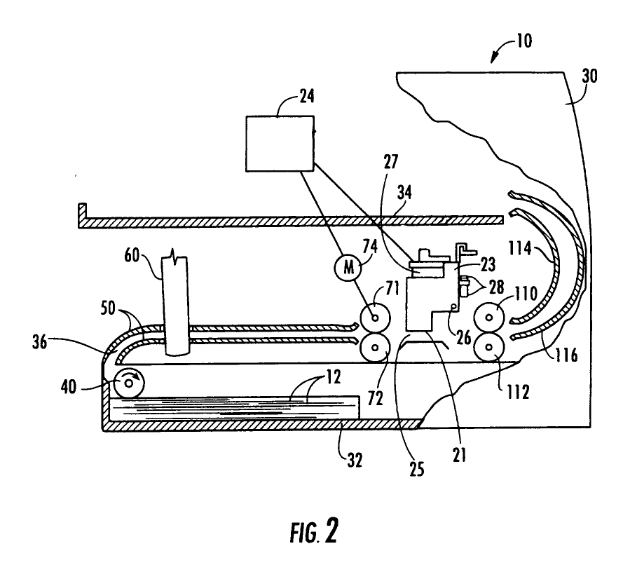

Referring specifically to FIG. 2, a printing apparatus, such as an inkjet printer 10 might comprise a printing device, such as one including print head 27, located about a print zone 25, such as within a printer housing 30. The print head 27 includes an ejector chip 21 comprising actuators associated with a plurality of discharge nozzles (not shown). An ink supply, such as an ink filled container, is in fluid communication with the ejector chip 21 (in the illustrated embodiment, the ink supply is integrally formed with the print head 27). The print head 27 is supported in a carrier 23 which, in turn, is supported on a guide rail 26 of the printer housing 30. A drive mechanism, such as a drive belt 28 is provided for effecting reciprocating movement of the carrier 23 and the print head 27 back and forth along the guide rail 26. As the print head 27 moves back and forth, it ejects ink droplets 14 via the ejector chip 21 onto a substrate 12 that is provided below it along a substrate feed path 36, to form a swath of information (typically having a width equal to the length of a column of discharges nozzles). As used throughout this description, the term “ink” is intended to include any aqueous or nonaqueous-based substance suitable for forming an image (or component thereof) on a substrate when deposited thereon.

A driver circuit 24 can provide voltage pulses to the actuators, such as resistive heating elements or piezoelectric elements (not shown) located in the ejector chip 21. In the case of resistive heating elements, each voltage pulse is applied to one of the heater elements to momentarily vaporize ink in contact with that heating element to form a bubble within a bubble chamber (not shown) in which the heating element is located). The function of the bubble is to displace ink within the bubble chamber such that a droplet of ink 14 is expelled from at least one of the discharge nozzles associated with the bubble chamber.

The printer housing 30 might include a tray 32 for storing substrates 12 to be printed upon. A rotatable feed roller 40 might be mounted within the housing 30 and positioned over the tray 32. Upon being rotated by a conventional drive device (not shown), the roller 40 grips the uppermost substrate 12 and feeds it along an initial portion of the substrate feed path 36. The feed path 36 portion is defined in substantial part by a pair of substrate guides 50. A coating apparatus 60 may optionally be used to apply a layer of coating material onto at least a portion of a first side of the substrate 12 prior to printing, such as to facilitate better print quality.

A pair of first feed rollers 71 and 72 might be positioned within the housing 30 between the optional coating apparatus 60 and the print head 27. They are incrementally driven by a conventional roller drive device 74 that can also be controlled by the driver circuit 24. The first feed rollers 71 and 72 incrementally feed the substrate 12 into the print zone 25 and beneath the print head 27. As noted above, the print head 27 ejects ink droplets 14 onto the substrate 12 as it moves back and forth along the guide rail 26 such that an image is printed on the substrate 12.

A pair of second feed rollers 110 and 112 can be positioned within housing 30 downstream from the print head 27. They are incrementally driven by a conventional roller drive device (not shown) that can be controlled by the driver circuit 24. The feed rollers 110 and 112 cause the printed substrate 12 to move through final substrate guides 114 and 116 to an output tray 34.

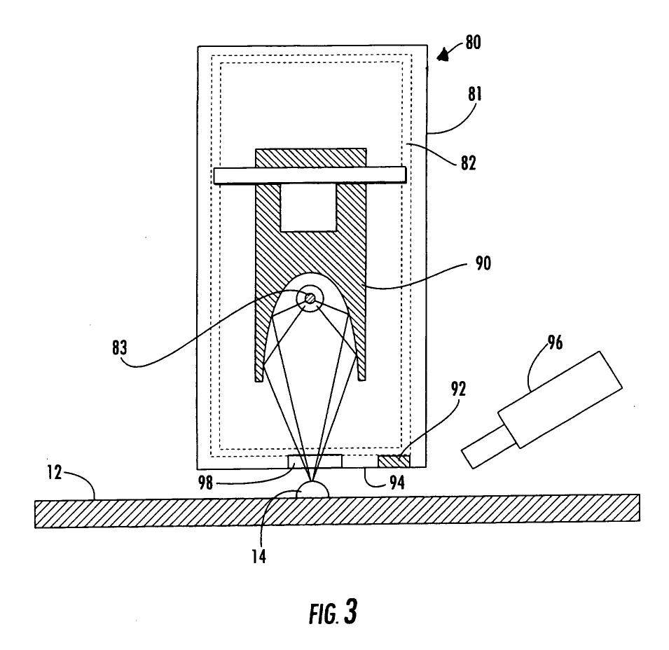

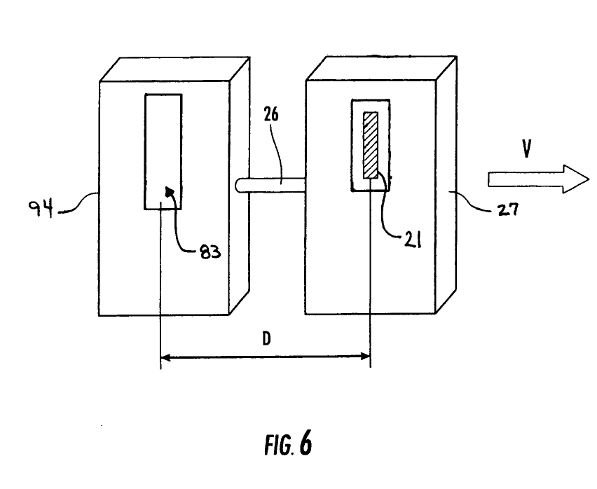

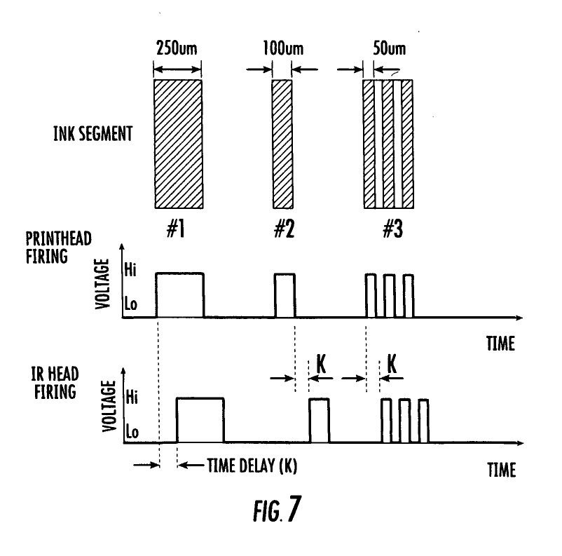

To fix the ink droplets 14 to the substrate 12, moisture should be driven from the ink and the substrate 12. While it is possible to dry the ink by natural air drying, natural air drying has proven to require excessive time and to be inefficient. Accordingly, as shown in FIGS. 3-6, positioned alongside the print head 27 can be a drying device 80 (also referred to herein as a “dryer”), in the form of, for example, a drying head 94 (see FIG. 6) capable of generating energy for heating and drying the ink droplets 14 deposited on the substrate 12 by the print head 27. The drying head 94 might be supported in the carrier 23, which in turn is supported on the guide rail 26 of the printer housing 30. The drying head 94 can be configured such that it moves at the same moving speed as a print head 27. In exemplary embodiments, the drying head 94 includes an enclosure 81 having a geometry and size similar to that of the print head 27 and which can be latched and loaded in a manner similar to the print head 27 and installed on carrier 23 by a latching mechanism (not shown). It will be understood by those skilled in the art that the enclosure 81 can be constructed from a high temperature thermosetting plastic such as phenolic or polyimide with a reflective coating inside 82. The enclosure 81 can also be made from a high temperature thermosetting such as phenolic or polyimide, or high temperature resistance thermoplastics such as polyethylene terephthalate (PET), polyester ketone (PEEK), Liquid crystal polymer (LCP), or any reinforced plastics. The reflective coating 82, or lining, is provided on the interior walls of the enclosure 81, whereby the reflective coating 82 is operable for preventing leakage of radiation.

Disposed within the enclosure is a radiant emitter 83. The radiant emitter 83 may be any conventional emitter that is, for example, operable to transfer energy to water molecules of the ejected ink droplets 14, thereby causing evaporation of the droplet's water molecules and facilitating a rapid, sub-second drying. In an exemplary embodiment, the emitter 83 is an infrared emitter. For example, the emitter 83 can be a short-wave infrared emitter. However, it will be understood by those skilled in the art that the emitter may be any emitter capable of transferring energy, including but not limited to, laser, ultra-violet, microwave, E-beam, or radio frequency emitters. The use of the infrared emitter 83 provides for a wider absorption bandwidth which can accommodate more types of printed substrates 12 for ink drying. Further, the use of an infrared emitter is currently more cost effective than other conventional electromagnetic wave emitters.

The selection of an infrared emitter (i.e., short-wave, medium-wave or long-wave) is dependent upon the characteristics of the ink compositions (generally water-based solutions) used and the substrate 12 to which the ink is applied. Various types of infrared emitters having distinct wavelength emissions to accommodate various characteristics of inks and substrates 12. By way of example, a short wavelength infrared emitter can be used to provide high radiant efficiency and a fast rate of response. By using this type of emitter, water absorption is low. Therefore, relatively high power could be used for substantially instantaneous water drying. Short wavelength infrared radiation typically has greater surface penetration and, therefore, if the substrate 12 is sensitive to the infrared radiation, an alternative may be required. Medium and long wavelength emitters operate at lower radiant efficiencies (more heat energy goes to convective heating) and have slower response times. However, water tends to absorb much of the radiation in this spectrum. Accordingly, medium and long wavelength infrared emissions are absorbed less by the substrate and provides for better surface heating. Thus, when the substrate 12 is sensitive to infrared radiation, these emitters may be desirable. Table 2 summarizes the characteristics of different exemplary types of infrared radiation which may be employed by the present invention.

TABLE 2
Characteristics of Infrared Wavelengths

| | Short-wave | Medium-Wave | Long-Wave |
|---|---|---|---|
| | High Intensity | Medium Intensity | Low Intensity |
| Radiant Source | 4000-2175° F. | 2175-847° F. | 857-400° F. |
| Temperature | | | |
| Peak Wavelength | 1.2-2.0 | 2.0-4.0 | 4.0-6.0 |
| Range, μm | | | |
| Watt Density, W/in² | Typical - 60 | Typical - 30 | Typical - 15 |
| | Max. - 1200 | Max. - 80 | Max. - 40 |
| Direct Radiation as | 86-72% | 60-40% | 50-20% |
| Percent of input | | | |
| Energy | | | |
| Relative heat-up | seconds | seconds to | Minutes |
| Cool-down time | | minutes | |
| Mechanical Shock | Poor | Good to excellent | Varies with |
| Resistance | | (for metal sheath) | design |

In exemplary embodiments of the present invention, the wave spectrum of the infrared emitter provides short waves with wavelengths ranging from about 800 to about 2,000 nm. Alternatively, the wave spectrum of the infrared emitter may provide medium waves with wavelengths ranging from about 2,000 to about 4,000 nm, or long waves with wavelengths ranging from about 4,000 to about 10,000 nm. Exemplary conventional, commercial emitters which may be used include the InGaAsP/InP semiconductor laser diodes with monochromatic continuous wave (CW) infrared radiation at a wavelength of about 1450 nm and Erbium:yttrium-aluminum-garnet (Er:YAG) semiconductor CW laser operating at a wavelength of about 2940 nm.

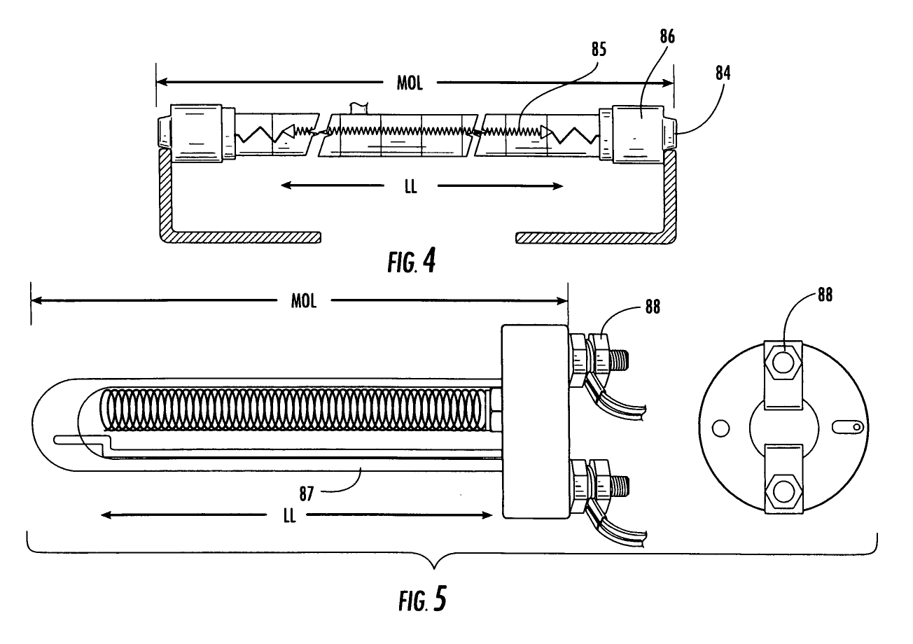

The emitter 83 can be mounted inside the enclosure 81 such that the wave emissions are directed toward the ejected ink droplets 14 on the substrate 12. As illustrated in FIG. 4, in one embodiment, the infrared emitter is a double end diode tube 84. The double end tube 84 generally includes a tube surrounding a resistive filament wire 85, such as a low-mass tungsten filament. The tube 84 is hermetically sealed and filled with an inert gas. Further, the tube 84 has a rapid heat up time and a rapid cool down time. The tube 84 surrounding the filament wire 85 essentially serves as a protective device for preventing the filament wire 85 from contacting other components of the printing apparatus. The maximum overall length (MOL) of the tube 84 might be less than about 2 inches in length such that the tube 84 fits within the enclosure 81. The heater length (LL) of the filament 85 might correspond to the length of the swath chip of the print head 21. For example, for a 0.5″ long ejector chip 21 with a 0.5″ swath, the LL may be 0.5″, and 1″ long with a 1″ swath chip. The tube 84 also includes a cap 86 which is less than about ¼″ due to the space restraints of the enclosure 81. Referring now to FIG. 5, an alternative embodiment of an infrared emitter is shown wherein a single end tube 87 is used as opposed to a double end tube 84. The configuration of the single end tube 87 dictates that the terminals 88 of the electrodes are located at one end for the electric connection. The use of a single end tube 87 reduces the MOL, thereby providing more space flexibility to accommodate shorter and/or longer swath chips.

A reflector 90 may be connected at the backside of the emitter tube operable for reflecting, collimating or focusing the infrared radiation to the front side of the emitter 83 toward the substrate 12. The reflector 90 may be a metal reflector having a generally parabolic configuration or a mirror having a generally spherical configuration, and may be positioned above the backside of the emitter 83 in order to direct the infrared radiation downward while focusing the radiation into a line beam. The reflector 90 can be positioned about a few centimeters above the emitter, thereby optimizing the focus of the infrared radiation. In another embodiment, the reflector 90 may be of a gold or silver composition. An optical lens, set of optical lenses or window 98 may be provided underneath the tube for focusing the parallel infrared radiation to a line source as small as about 100 microns depending on the distance between the lens and the surface of the substrate 12.

The infrared emitter is controlled and driven by an electric circuit (not shown), such as one supplying an approximate voltage of about 12 to about 120 V, with a current of about 270 mA to about 5 A. In exemplary embodiments, the circuit is attached to one side of the enclosure 81. Further, the circuit is capable of switching the power on or off to the infrared emitter in response to information on data printed and positioned in need of drying, on the calibrated output of the infrared source, and on feedback from a pyrometer 92 with respect to the dry state of the ink. The infrared source may be calibrated in a maintenance station (not shown) of the printer 10. This calibration may consist of exciting the infrared source with current and then comparing sensor values with time to the expected values. This information may be used to set either the time or voltage during subsequent usage.

The pyrometer 92 may be installed at the dryer head 94 and can be focused on the surface of the printed substrate 12 in order to measure the temperature of the ink. The measured temperature may be converted to electronic signals in order to control the intensity of the emitted infrared radiation. With the temperature control device, overheating and burning of the printed substrate 12 may be avoided. In addition, a power sensor (not shown) may be provided and operatively connected to the maintenance station of the printer 10 in order to perform periodic measurements of the power coming from the infrared emitter in the case of a sudden decay of the heater or a broken heating element.

An exhaust 96 may be provided in order to remove water vapor from the enclosure 81. Based on the reciprocating carrier 23 speed and movement, there may be convection and removal of the vapor generated during exposure to the infrared heat. However, in order to increase efficiency, baffles or fins (not shown) may be designed into the enclosure 81 for the purpose of increasing air flow. Another method of removing vapor may include diverting the cooling medium air so that it flows over the deposited ink. Yet another method may involve positioning a small vacuum pump in order to help exhaust the vapors. A provision for cleaning the lamp may be provided in the maintenance station.

A medium wave infrared emitter tube (not shown) with a length similar to the substrate 12 width may optionally be installed at the entrance or exit location of the substrate feed path 36 in the housing 30. An infrared tube installed at about the entrance of the housing 30 may preheat the substrate 12 and remove moisture on the surface thereof in order to improve the wettability of the ink on the substrate 12. An infrared emitter tube installed about the exit of the housing 30 ensures the drying of the ink. Preheating may help to alter both the surface energy of the substrate 12, making the ink wet better, and also remove any excess moisture off the substrate 12 to be printed on. This might be especially useful when printing on ink receptor layers because it should help dry the layer and improve water absorption efficiency. Not only does a preheating step reduce the amount of time necessary to dry the ink droplets 14 once deposited on the substrate 12, but it may also help to improve image quality by reducing the paper cockle and curl that often results from moisture remaining in the substrate 12. Heating the ink substantially immediately after printing helps evaporate the low boiling materials quickly and increases the local viscosity of the ink for fixing and improving homogeneity.

FIG. 6 illustrates an exemplary configuration of a synchronized printing and drying system. A drying head 94 is located about the left hand side of a print head 27 and is supported by a carrier 23, the carrier is in turn supported by a guide rail 26. Both the drying head 94 and the print head 27 are electronically synchronized in such a way that printing and drying of any individual ink droplet 14 is separated by an equal amount of time. In an exemplary embodiment, the desired power intensity delivered from, for example, an infrared emitter of the drying head 94, might be in the range from about 100 watts/cm² to about 1000 watts/cm², based on the energy requirements. The moving speed of the system can be adjusted to an appropriate speed for sub-second drying, a range from about 100 mm/sec to about 500 mm/sec is exemplary.

FIG. 7 illustrates control diagrams of the print head 27 and an infrared emitter of the drying head 94 for printing and drying of three ink segments on a single line printing. The width of the first ink segment (illustrated at the left-hand side of the diagram) is about 250 microns, which is composed of 5 printed lines based on the assumption of a 50 micron ink spot size. The second ink segment is about 100 microns wide, which only requires two printed lines in order to fill the segment. The third segment, which is illustrated on the right hand side of the diagram, is again about 250 microns wide but has two non-printed lines arranged alternatively within the segment. In the print head control diagram, the print head 27 fires/ejects the ink out the discharge nozzle at high voltages, and remains idle at low voltages. In the drying head diagram, the infrared emitter is triggered and held at a constant time delay (K) relative to the firing frequency of the print head 27. The time delay can be determined by the center-to-center distance (D), as referred to in FIG. 6, between the ejector chip 21 of print head 27 and the emitter 83 of drying head 94, the moving speed (V) of the common carrier, and the time constant (tc) of the infrared emitter, in the form of the following equation:
K=D/V+tc

In a exemplary configuration, the distance D is about 25 mm. With a moving speed of 100 mm/sec, together with a time constant of infrared emitter at 0.1-0.3 sec (short wave emitter), the time delay is between 0.35 to 0.55 seconds. By synchronizing the electric signals driving the print head 27 and the infrared emitter, the time between printing and drying is constant. In doing so, all of the printed drops/lines have an equal amount of dwell time prior to being exposed to infrared radiation. With a water extinction rate of 0.01 seconds under 500 watts/cm², sub-second heating and drying can be achieved, making the ink deposition and drying more uniform across the entire substrate 12.

By employing the use of a synchronized printing and drying system within an inkjet printing process, as described herein, the aforementioned shortcomings of the prior art can be overcome. Indeed, several advantages of exemplary embodiments are apparent. First, a fast and efficient printing and drying system can be provided, whereby the ink is deposited upon a substrate 12 and thereafter rapidly dried in a constant, sub-second manner. Further, a pulsing control of an infrared emitter that is used for drying the ink can be provided such that the emissions will not overheat the substrate 12.

Still further, the methods and apparatus of the exemplary embodiments of the present invention may be used to increase optical density by reducing penetration of pigmented inks. One of the challenges of printing pigmented inks on plain paper media is keeping the pigment on the surface of the paper (minimize penetration) such that a higher optical density can be achieved. Chemical modifications of the pigment, dispersant, etc. can lead to adverse side effects such as poor gloss on photographic media or poor print function. By exposing the deposited pigmented ink on the substrate to sub-second radiation and evaporating the low boiling materials as quickly as possible on the plain media, the level of penetration within the media which causes poor color is minimized. Accordingly, the quality of the colorant of the pigmented ink on the surface of the media is optimized. With the system described herein, this can be readily achieved by preheating the substrate with the IR element and/or fast heating of the ink upon jetting. Furthermore, because of the constant time delay, an exemplary embodiment of the present invention is capable of providing equal heating profiles to different regions of the printed area in order to minimize color non-uniformity.

Still further, the methods and apparatus of the exemplary embodiments of the present invention may be used to provide improved interaction between two or more components in reactive and non-reactive systems. For example, an additional application of sub-second heating with constant delay in between printing and heating involves the coating of systems including more than one component where each component is located in a separate print head, e.g., 2 part epoxy systems in which the epoxy (Part A) is located in one print head and the curing agent (Part B) in located in another print head. Such systems experience diffusion and reaction kinetics in addition to the surface chemistry. In such an embodiment, it should be imperative to have proper control on the diffusion time of the components and the reaction rates.

Prior art deposition techniques may involve depositing parts A and B during a time period depending on the coating geometry, carrier speed, etc. The entire coating would then be exposed to a heat treatment in order to bring about a specific chemical reaction. Problems arise in the coating time distribution. Droplets of A and B printed at the beginning of the coating process would experience a longer dwell time before thermal ramping begins. Depending on the system, this may cause severe coating differences attributed to print time variation. Thus, in an ideal system such as that provided by exemplary embodiments of the present invention, there is an equal time delay for all fluids printed.

It will be apparent to those skilled in the art that various modifications and variations can be made to the present invention without departing from the spirit and scope of the invention. Thus, it is intended that the present invention cover all conceivable modifications and variations of this invention, provided those alternative embodiments come within the scope of the appended claims and their equivalents.

What is claimed is:

1. A printing system, comprising:
a printing device operable for depositing one or more inks upon a substrate; and
a drying device operable for emitting a pre-selected wavelength of electromagnetic radiation for the purpose of drying the one or more inks in a predetermined time period subsequent to the deposition of the one or more inks upon the substrate; and
wherein the printing device and the drying device are operated at about the same moving speed.

2. The printing system according to claim 1, wherein the deposition of the one or more inks and the drying of the one or more inks are synchronized.

3. The printing system according to claim 1, wherein a moving speed of the printing device and a moving speed of the drying device are synchronized.

4. The printing system according to claim 1, further comprising a guide rail system for supporting a carrier device, and wherein the carrier device is operable for supporting the printing device and the drying device.

5. The printing system according to claim 1, wherein the predetermined time period is less than about one second.

6. The printing system according to claim 1, further comprising a reflector operable for at least one of reflecting, collimating and focusing the radiation.

7. The printing system according to claim 1, wherein the wavelength comprises one of an infrared, ultra-violet, radio frequency and microwave wavelength.

8. The printing system according to claim 1, further comprising an exhaust operable for removing water vapor from the printing system.

9. The printing system according to claim 1, further comprising an electrical circuit operable for controlling the printing device and the drying device.

10. The printing system according to claim 1, further comprising a pyrometer positioned about the substrate and operable for monitoring a temperature of the substrate and the environment adjacent the substrate.

11. The printing system according to claim 1, further comprising a sensor operable for monitoring the power emitted by the drying device.

12. The printing system according to claim 1, further comprising one or more heating devices positioned about at least one of a feeder entrance and a feeder exit operable for at least one of preheating the substrate and drying the substrate.

13. The printing system according to claim 1, wherein the drying device includes real-time temperature control for drying.

14. The printing system according to claim 1, wherein the drying device includes a radiant emitter having a tubular body surrounding a filament wire operable for generating energy, the filament wire having a heater length corresponding to a dimension of a swath that can be produced by the printing device.

15. The printing system according to claim 1, wherein the drying device emits energy having a power intensity in the range of about 100 watts/cm² to about 1000 watts/cm².

16. A printing system, comprising:
a housing;
a rail supported within the printer housing operable for supporting and guiding a carrier device;
a printing device supported by the carrier device operable for depositing one or more inks onto a substrate; and
a drying device positioned about the printing device and supported by the carrier device, wherein the drying device is operable for emitting energy towards the one or more deposited inks for the purpose of drying the one or more inks subsequent to deposition of the one or more inks onto the substrate; and
wherein the printing device and the drying device move in a synchronized manner along the rail.

17. The printing system according to claim 16, wherein the energy emitted is selected from the group consisting of thermal energy, infrared wavelengths, ultra-violet wavelengths, radio frequency wavelengths, microwave wavelengths and electron-beam energy.

18. The printing system according to claim 16, further comprising a reflector operable for reflecting, collimating or focusing the energy, an electrical circuit operable for controlling the printing device and the drying device, a pyrometer positioned about the substrate operable for monitoring a temperature, and a sensor operable for monitoring the power emitted by the drying device.

19. A method of printing, comprising:
depositing one or more inks onto a substrate using a printing device; and
drying the one or more deposited inks using a drying device operable for emitting pre-selected wavelengths of energy that are focused onto the one or more deposited inks in a predetermined time period subsequent to ink deposition;
wherein the depositing and the drying are synchronized.

20. The method of printing according to claim 19, wherein the predetermined time period is less than about one second.

21. The method of printing according to claim 19, wherein the printing device and the drying device are supported by a common carrier device and move at about an equal moving speed.

22. The method of printing according to claim 19, wherein the drying device includes a real-time temperature control for drying and a sensor for monitoring emitted power and temperature.

23. The method of printing according to claim 19, wherein the printing device and the drying device are controlled by a control module operable for synchronizing the printing and the drying.

24. The method of printing according to claim 19, further comprising the preheating the substrate prior to depositing the one or more ink in order to remove moisture from the substrate.

25. The method of printing according to claim 19, further comprising reflecting and focusing the emitted energy to the substrate using a reflecting device, and exhausting water vapor from the printing environment.

26. A method of printing comprising depositing one or more inks onto a substrate and drying the deposited one or more inks subsequent to ink deposition by exposing the one or more deposited inks to energy emitted from a drying device, wherein a printing device and the drying device are supported by a common carrier that moves along a rail of a printer, and wherein the operation of the printing device and the drying device are synchronized by a control module.

27. The method of printing according to claim 26, wherein the one or more deposited inks are dried within less than one second after being deposited onto the substrate.

28. The method of printing according to claim 26, wherein the energy emitted is at least one of thermal energy, infrared radiation, ultra-violet radiation, microwave radiation and electron-beam energy.

29. The method of printing according to claim 26, wherein the depositing of one or more inks onto a substrate and the drying of the deposited one or more inks are performed in a thermal ink jet system.

30. The method of printing according to claim 26, wherein the depositing of one or more inks onto a substrate and the drying of the deposited one or more inks are performed in a piezoelectric ink jet system.
